(19) United States
(12) Patent Application Publication
(10) Pub. No.: US 2016/0034268 A1
(43) Pub. Date: Feb. 4, 2016

(54) Managing Firmware Updates

(71) Applicant: HEWLETT-PACKARD DEVELOPMENT COMPANY, L.P., Houston, TX (US)

(72) Inventors: Andrew BROWN, Houston, TX (US); David Kimler ALTOBELLI, Houston, TX (US); Leopoldo ALANIZ, Spring, TX (US); Andrew C. CARTES, Cypress, TX (US)

(21) Appl. No.: 14/782,206

(22) PCT Filed: Apr. 3, 2013
(86) PCT No.: PCT/US13/35163

§ 371 Date: Oct. 2, 2015

(51) Int. Cl. G06F 9/445; H04L 29/08; G06F 9/44

(52) U.S. Cl. CPC G06F 8/65; G06F 8/71; H04L 67/34

(57) ABSTRACT

A system and method are disclosed herein. The computing system includes a blade enclosure to receive a plurality of cartridges. The computing system also includes an enclosure manager in the blade enclosure to manage the plurality of cartridges. The enclosure manager determines that a cartridge includes updated firmware, and propagates the updated firmware to the plurality of cartridges.

### BACKGROUND

Firmware is program code and data stored in persistent memory. Firmware can be updated for a variety of reasons, such as fixing problems or adding features. Current methods of updating firmware include a user manually acquiring the updated firmware, such as by downloading the updated firmware through the internet.

### BRIEF DESCRIPTION OF THE DRAWINGS

Certain examples are described in the following detailed description and in reference to the drawings, in which:

FIG. 1 is a block diagram of an example of a computing system;

FIG. 2 is an illustration of an example of a communication pathway within a blade enclosure;

FIG. 3 is a process flow diagram illustrating an example of a method of updating firmware;

FIG. 4 is a process flow diagram illustrating an example of a method of updating firmware;

FIG. 5 is a block diagram of an example of a tangible, non-transitory, machine-readable medium; and

FIG. 6 is a block diagram of an example of a computing system.

### DETAILED DESCRIPTION OF SPECIFIC EXAMPLES

Techniques described herein relate generally to firmware. More specifically, techniques described herein relate to updating firmware. Networked computing systems generally include host computing devices configured to provide resources such as storage, applications, databases, and the like. The host computing device may be a server such as a database server, file server, mail server, print server, web server, or some other type of server configured to provide services to client devices within a network.

A blade server is a server computer having a modular design optimized to minimize the use of physical space. Whereas a standard rack mount server can function with a power cord and network cable, a blade server has many components removed for the purpose of saving space, minimizing power consumption and other considerations, while still having all the functional components to be considered a computer. A multi-slot chassis can hold multiple blade server cartridges and provide shared resources such as power, cooling, networking, various interconnects, and management.

Each blade server cartridge typically includes firmware. The firmware can be updated when new versions become available. Current approaches to deliver the updated firmware commonly include web or download approaches in which updated firmware is downloaded from a network connection, such as the internet. However, download approaches consume additional resources, increasing the cost of performing firmware upgrades. In another approach, an additional device can manage firmware updates for a plurality of blade server enclosures. However, the additional device employs additional infrastructure, increasing costs and complexity.

By automatically registering updated firmware in a newly installed cartridge, the hardware cartridge becomes a delivery mechanism. Upon installation in a blade enclosure, the updated firmware can be retrieved from the hardware and used as a source for upgrading other components in the blade enclosure, such as through normal practices.

Additionally, a flashing process in which data is erased and new data written is used in updating firmware. In traditional systems there is little consideration for latencies or other flashing issues as a direct connection allows for the most rapid flashing process. However, in an intermediate management network used to flash firmware components, the efficiency solution/flashing time-burden is different in a distributed environment where the management architecture is part of the flashing process and components are not directly connected to a microcontroller performing the flashing. The latencies of flashing across this environment alters the concerns of read, erase, and write operations allows for the background process to obtain information to make the flashing process as efficient as possible. In this intermediate management network, the time used for a read operation and calculation to determine if a write is preferable may be more efficient than an erase and write. Options of performing read operations to either fully compare, or calculate a HASH and compare, can make the entire flashing process more efficient by only erasing and writing the portions of the flash that are necessary. In a shared enclosure, these operations can be performed to build the information to flash most efficiently at a later point in time.

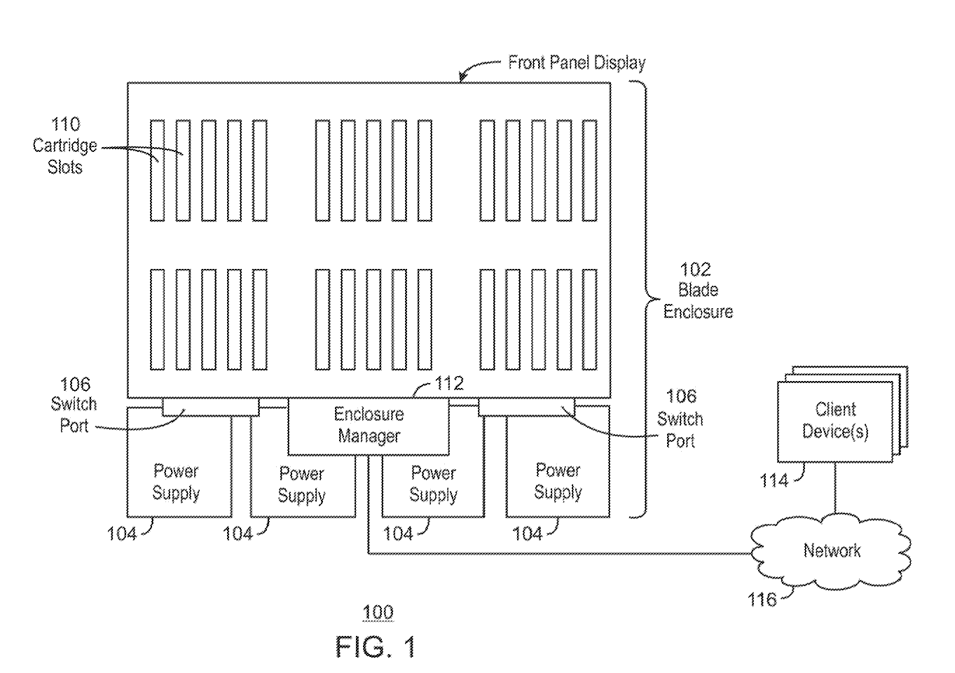

FIG. 1 is a block diagram of an example of a computing system. The computing system 100 includes a blade enclosure 102. The blade enclosure 102 includes a power supply 104. In an example, the blade enclosure 102 can include a single power supply 104. In another example, the blade enclosure 102 can include a plurality of single power supplies 104, such as two, three, four, or more power supplies 104. The blade enclosure 102 also includes switch ports 106 to connect to additional devices. In addition, the blade enclosure 102 includes a front panel display 108.

The blade enclosure includes a plurality of cartridge slots 110. Installed in each cartridge slot 110 is a cartridge (not shown). The cartridge can include firmware. The cartridges can include multiple firmware, such as serial peripheral interface (SPI) flash, complex programmable logic device (CPLD) logic gates, I2C electrically erasable programmable read only memory (EEPROM), etc. The firmware can be stored in multiple hardware locations, such as read only memory (ROM), complex programmable logic device (CPLD), field replaceable unit (FRU), etc. If the firmware of a newly installed cartridge is more current than the firmware of currently installed cartridges, the firmware is propagated to the cartridges installed in the blade enclosure 102.

The blade enclosure 102 further includes an enclosure manager 112. The enclosure manager 112 manages the operation of the blade enclosure 102. In addition, the enclosure manager 112 manages operation of the cartridges in the cartridge slots 110. In an example, the enclosure manager 112 manages a plurality of cartridges. In another example, the enclosure manager 112 manages all of the cartridges in the enclosure 102. The enclosure manager 112 can be remote from the cartridges.

The enclosure manager 112 can be coupled to a client device 114 via a network 116. The enclosure manager 112 can provide resources, such as networked resources, to the client device 114 via the network 116. In an example, the enclosure manager 112 can be coupled to a plurality of client devices 114.

The block diagram of FIG. 1 is not intended to indicate that the computing system 100 is to include all of the components shown in FIG. 1. Further, the computing system 100 may include any number of additional components not shown in FIG. 1, depending on the details of the specific implementation.

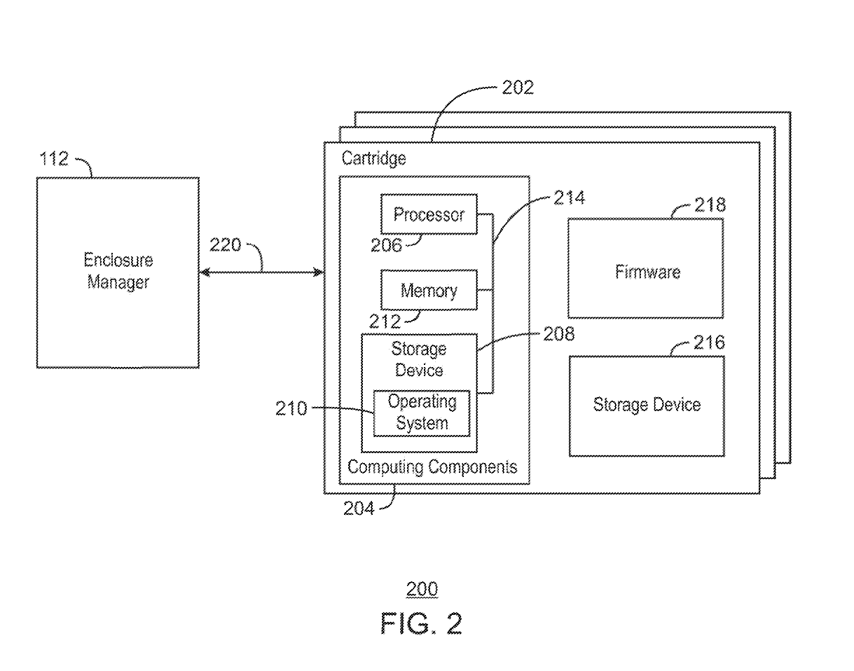

FIG. 2 is an illustration of an example of a communication pathway within a blade enclosure. A cartridge 202 can include computing components 204. In an example, the cartridge 202 includes a microcontroller (not shown) to monitor the computing components 204. The microcontroller may receive data associated with the operation of the computing components 204, and provide the data to the enclosure manager 112. The cartridge 202 can be one of many cartridges. The computing components 204 can be host computing devices including servers configured to provide networked resources to client devices via a network (not shown).

The computing components 204 can include various components such as a processor 206 and a storage device 208, comprising a non-transitory computer-readable medium. The storage device 208 can also include an operating system 210. The operating system 210 can be executed by a processor of a host computing system such as the processor 206 of the computing components 204. In some examples, the storage device 208 has instructions stored thereon that, when executed by the processor 206, cause the computing components 204 to perform operations. In some examples, the operations include responding to requests from one of the client devices. The processor 206 can be a main processor that is adapted to execute stored instructions. The computing components 204 can also include a memory device 212 that, in some examples, stores instructions that are executable by the processor 206. The processor 206 can be a single core processor, a multi-core processor, a computing cluster, or any number of other configurations. The processor 206 can be implemented as Complex Instruction Set Computer (CISC) or Reduced Instruction Set Computer (RISC) processors, x86 Instruction set compatible processors, multi-core, or any other microprocessor or central processing unit (CPU).

The memory device 212 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems. The main processor 206 can be connected through a system bus 214 (e.g., PCI, ISA, PCI-Express, HyperTransport®, NuBus, etc.) to the other computing components 204.

The cartridge 202 can also include storage device 216. The storage device 216 can be remote and separate from the storage device 208 of the computing components 204. In an example, the storage device 216 can be an electrically erasable programmable read-only memory (EEPROM) device. The storage device 216 includes instructions defining a configuration of the computing components 204 of the cartridge 202. The instructions in the storage device 204 include: standard product information in intelligent platform management interface (IPMI)/field replaceable unit (FRU) format, abstraction tables (including GPI/O, I2C Buses and Devices, SPI Buses, Firmware UUIDs, Serial Console), thermal tables, IPMI sensor data records (SDRs), and the like. The cartridge 202 includes firmware 218 configured to receive the instructions from the storage device 216. In an example, the firmware 218 is stored in storage device 216.

The computing components 204 can be a host computing device such as a server. In this example, the cartridge 202 is one of a plurality of cartridges of a multi-cartridge server system 100. However, the computing components 204 at each cartridge 202 can be any combination of computing resources such as storage devices, processors, memory devices, and the like. In either example, the cartridge 202 interfaces with the enclosure manager 112, which is remote from the cartridge 202. The enclosure manager 112 can include a processor, storage, and memory, such as the processor 206, storage device 208, and memory device 212 of the computing components 204 of FIG. 1. The enclosure manager 112 can be communicatively coupled to a plurality of cartridges 202, via an interface 220. In some examples, the interface 220 is an Ethernet bus, wherein the data based on the monitoring of the computing components 204 is provided to the enclosure manager 112 via Internet Protocol (IP).

The enclosure manager 112 registers installation of a cartridge 202 in a blade enclosure, such as blade enclosure 102. When the enclosure manager 112 registers installation of the cartridge 202, the enclosure manager 112 analyzes the firmware 218 of the cartridge 202 in order to determine the version of the firmware 218. After determining the version of the firmware 218, the enclosure manager 112 determines if the version of the firmware 218 is more current than an existing firmware of the currently installed cartridges. For example, the enclosure manager 112 can examine normal version or data fields of the firmware images to determine if the firmware images are more recent that existing firmware images. In an example, the enclosure manager 112 determines if the version of the firmware 218 is more current by comparing the version data of the firmware 218 with the version data of the current firmware. In an example, the enclosure manager 112 determines if the version of the firmware 218 is different from an existing firmware by performing a HASH calculation. A HASH calculation is a calculation that can be used to detect changes in a large data set by producing a unique (smaller) HASH value. The smaller HASH values can be compared to determine if a difference is present rather than comparing a complete large data sets to determine differences or equivalence. By using a HASH calculation, the enclosure manager 112 is able to detect updated firmware in a generic way, without knowing details regarding version/date information. Suitable logging or LED notification can be employed to note the performance of the firmware update. By logging the performance of a firmware update, a customer or service personnel can be informed of the firmware update.

If the enclosure manager 112 determines that the firmware 218 is not an updated version compared to the existing firmware, the enclosure manager 112 makes no changes to the firmware of the installed cartridges. For example, if the enclosure manager 112 determines that the version of the firmware 218 is the same version as the current firmware of the blade enclosure, the enclosure manager 112 makes no changes to the current firmware of the blade enclosure. Alternatively, if the enclosure manager 112 determines that the version of the firmware 218 is less current than the current firmware of the blade enclosure, the enclosure manager 112 can propagate the current firmware of the blade enclosure to the newly installed cartridge 202.

If the enclosure manager 112 determines that the firmware 218 is an updated version compared to the existing firmware in the blade enclosure, the enclosure manager 112 can extract the updated firmware 218 and store the firmware 218 in a database. For example, the enclosure manager 112 can store the firmware 218 in a local database.

After storing the updated firmware 218 in a database, the enclosure manager 112 can propagate the firmware 218 to the other cartridges installed in the blade enclosure. The enclosure manager 112 can propagate the firmware 218 to installed cartridges manually or in an automated fashion, as if the images were delivered through traditional updating methods. For example, the enclosure manager 112 can propagate the firmware 218 to installed cartridges using a flashing process, such as an optimal flashing process. By propagating the firmware 218 to the other cartridges, the enclosure manager 112 creates a baseline of activity among the cartridges installed in the blade enclosure. By propagating the firmware 218 to the other cartridges, the cartridge 202 acts as a hardware delivery mechanism of updated firmware. The enclosure manager 112 can automatically detect and propagate updated firmware from the cartridge 202 to the installed cartridges. By automatically detecting and propagating updated firmware, the use of additional resources and/or infrastructure in updating firmware can be eliminated. For example, by automatically detecting and propagating updated firmware from a hardware cartridge installed in a blade enclosure, a user need not perform additional steps to perform a firmware upgrade, such as downloading the upgrade from the internet.

In a further example, an updated firmware 218 can be propagated to additional blade enclosures communicably coupled to the blade enclosure in which the cartridge is installed. By propagating the updated firmware 218 to additional blade enclosures, the firmware of cartridges installed in the additional blade enclosures can be updated. As such, a baseline of programmable behavior can be achieved between multiple cartridges of multiple blade enclosures of a computing system.

The firmware 218 can include a signature or other form of protection to protect the data integrity of the firmware 218 and assure that the firmware 218 is valid and/or from a known source. The contents of the firmware 218 are validated, such as through a signature, in order to prevent circumvention of normal security methods. The signature area of the firmware 218 is only produced if the firmware 218 is from a known and/or trusted source.

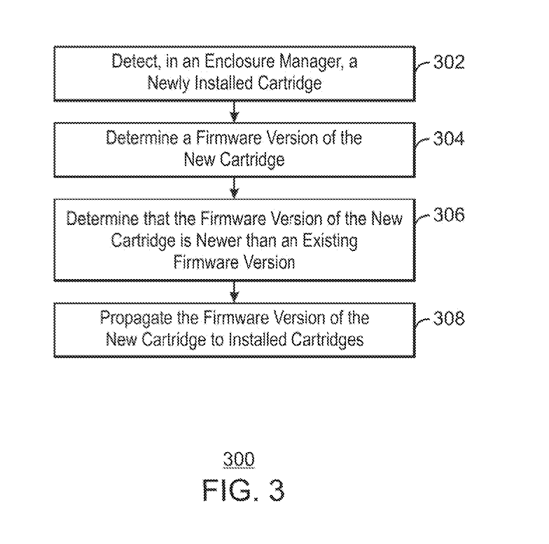

FIG. 3 is a process flow diagram illustrating an example of a method 300 of updating firmware. At block 302, a newly installed cartridge is detected in an enclosure manager. The enclosure manager can be in a blade server enclosure. In an example, the enclosure manager manages multiple cartridges. In another example, the enclosure manager manages all cartridges in the enclosure.

At block 304, a firmware version of the new cartridge is determined. The firmware version of the new cartridge can be determined by the enclosure manager. In an example, the enclosure manager can determine the firmware version of the new cartridge by examining the firmware images. In another example, the enclosure manager can determine the firmware version of the new cartridge by examining identifying version data.

At block 306, the enclosure manager can determine that the firmware version of the new cartridge is newer, or more current, than an existing firmware version. For example, the enclosure manager can determine that the firmware version of the new cartridge is different using a HASH calculation.

At block 308, the enclosure manager can propagate the firmware version of the new cartridge to installed cartridges. By propagating the firmware version of the new cartridge to installed cartridges, the enclosure manager can achieve a common baseline of behavior among the installed cartridges.

In addition, the firmware can include a signature or other form of protection to protect the data integrity of the firmware and assure that the firmware is valid and/or from a known source. The enclosure manager can validate the contents of the firmware, such as through a signature, in order to prevent circumvention of normal security methods. The signature area of the firmware is only produced if the firmware is from a known and/or trusted source. The enclosure manager can validate the signature and only propagate firmware originating from a known and/or trusted source.

It is to be understood that the process flow diagram of FIG. 3 is not intended to indicate that the blocks 302-308 are to be executed in any particular order, or that all of the blocks 302-308 are to be included in every case. Further, any number of additional processes not shown in FIG. 3 may be included within the method 300, depending on the details of the specific implementation.

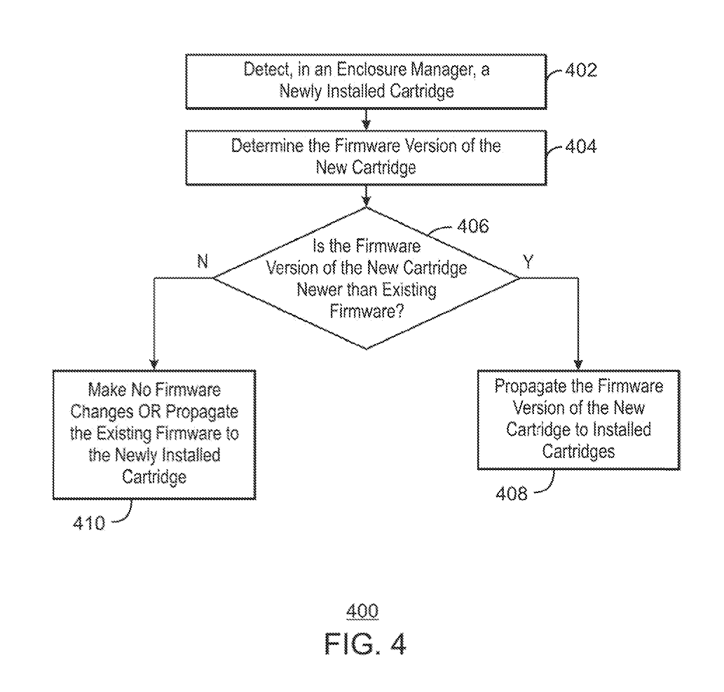

FIG. 4 is a process flow diagram illustrating an example of a method 400 of updating firmware. At block 402, a newly installed cartridge can be detected in an enclosure manager. The cartridge is installed in a blade enclosure. The enclosure manager can be located in the blade enclosure. In an example, the enclosure manager manages multiple cartridges. In another example, the enclosure manager manages all cartridges in the enclosure.

At block 404, the firmware version of the new cartridge is determined. The enclosure manager can determine the firmware version of the new cartridge. In an example, the enclosure manager can determine the firmware version of the new cartridge by examining the firmware images. In another example, the enclosure manager can determine the firmware version of the new cartridge by examining identifying version data.

At block 406, the enclosure manager determines if the firmware version of the new cartridge is newer than the existing firmware. The enclosure manager can make the determination of a difference in the firmware version using any suitable method, such as with a HASH calculation. If the firmware version of the new cartridge is newer than the existing firmware, then at block 408 the enclosure manager propagates the firmware version of the new cartridge to the installed cartridges. By propagating the firmware version of the new cartridge to installed cartridges, the enclosure manager can achieve a common baseline of behavior among the installed cartridges. If the enclosure manager determines that the firmware version of the new cartridge is not newer than the existing firmware, then at block 410 the enclosure manager can make no changes to the firmware or the enclosure manager can propagate the existing firmware to the newly installed cartridge.

In addition, the firmware can include a signature or other form of protection to protect the data integrity of the firmware and assure that the firmware is valid and/or from a known source. The enclosure manager can validate the contents of the firmware, such as through a signature, in order to prevent circumvention of normal security methods. The signature area of the firmware is only produced if the firmware is from a known and/or trusted source. The enclosure manager can validate the signature and only propagate firmware originating from a known and/or trusted source.

It is to be understood that the process flow diagram of FIG. 4 is not intended to indicate that the steps of the method 400 are to be executed in any particular order, or that all of the steps of the method 400 are to be included in every case. Further, any number of additional steps not shown in FIG. 4 may be included within the method 400, depending on the details of the specific implementation.

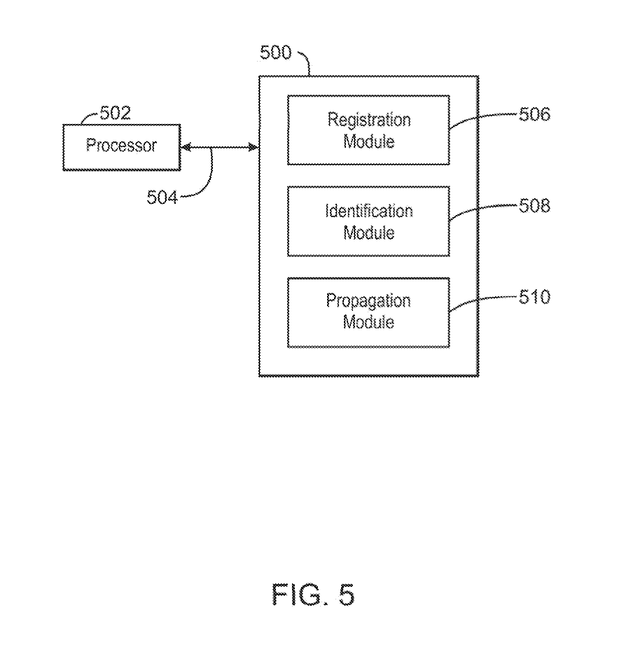

FIG. 5 is a block diagram showing tangible, non-transitory, machine-readable medium 500 that propagates updated firmware from a cartridge to additional cartridges. The machine-readable media 500 can be accessed by a processor 502 over a bus 504. Furthermore, the machine-readable media 500 can include code to direct the processor 502 to perform the steps of the current method.

The various software components discussed herein may be stored on the tangible, non-transitory, machine-readable medium 500, as indicated in FIG. 5. For example, an allocation module 506 can direct the processor 502 to register the installation of a new cartridge in a blade enclosure. An identification module 508 can direct the processor 502 to identify the version of the firmware of the new cartridge and to determine if the version of the firmware of the new cartridge is more current than existing firmware of the blade enclosure. A propagation module 510 can direct the processor 502 to propagate the version of the firmware of the new cartridge to other cartridges installed in the blade enclosure when the identification module 508 determines that the firmware version of the new cartridge is more current than existing firmware.

It is to be understood that FIG. 5 is not intended to indicate that all of the software components discussed above are to be included within the tangible, non-transitory, machine-readable medium 500 in every case. Further, any number of additional software components not shown in FIG. 5 can be included within the tangible, non-transitory, machine-readable medium 500, depending on the specific implementation.

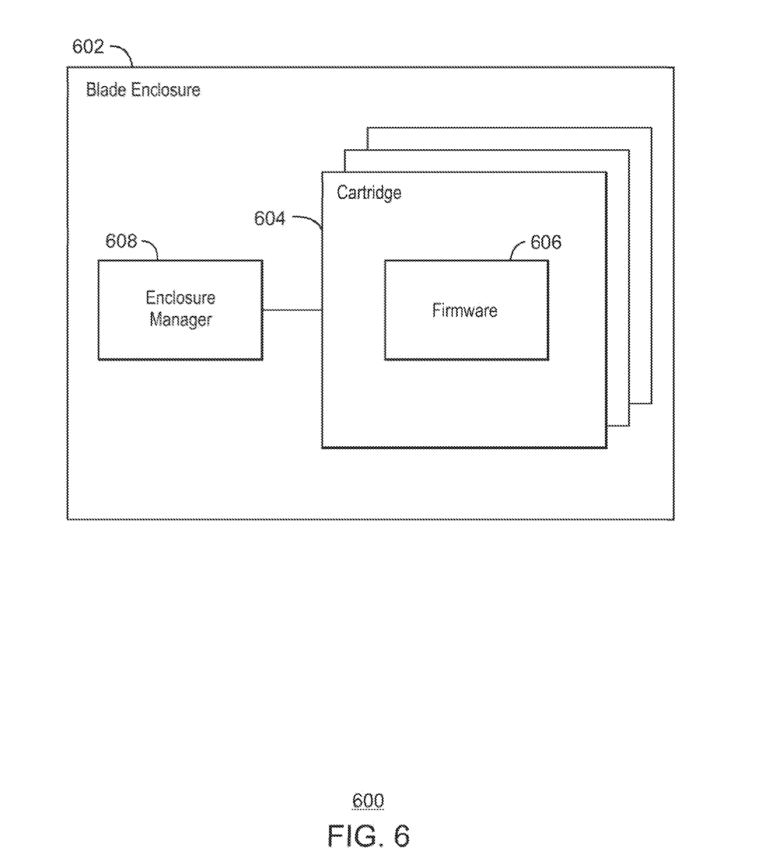

FIG. 6 is a block diagram of an example of a computing system. The computing system 600 includes a blade enclosure 602. The blade enclosure receives a plurality of cartridges 604. The cartridges 604 can include a plurality of computing components (not shown). The cartridges 604 can also include firmware 606.

The blade enclosure can also include an enclosure manager 608. The enclosure manager 608 manages the cartridges 604 and monitors the activity of the cartridges 604. The enclosure manager 608 also registers the addition of a new cartridge 604 to the blade enclosure 602. The enclosure manager 608 can determine if the firmware 606 of the new cartridge 604 is more up-to-date than the firmware of the other cartridges. If the enclosure manager 608 determines that the firmware 606 of the new cartridge 604 is more up-to-date, the enclosure manager 608 can propagate the new firmware 606 to the other cartridges in the blade enclosure 602. In an example, the enclosure manager 608 can also propagate the updated firmware 606 to other blade enclosures 602 in a computing system, such as by sending the updated firmware 606 to an enclosure manager(s) of an additional blade enclosure(s) for propagating to the cartridges of the additional blade enclosure(s). In another example, the enclosure manager 608 can be one of a plurality of managers (not shown) for managing cartridges. In this example, when the enclosure manager 608 registers new firmware 606, the enclosure manager 608 can communicate the updated firmware 606 to the additional managers of the enclosure for propagating to the cartridges 604 managed by the additional managers.

### Example 1

A computing system is described herein. The computing system includes a blade enclosure to receive a plurality of cartridges. The computing system also includes an enclosure manager in the blade enclosure to manage the plurality of cartridges. The enclosure manager is to determine that a cartridge includes updated firmware, and propagates the updated firmware to the plurality of cartridges.

The enclosure manager can be to register installation of a newly installed cartridge, determine a version of the firmware of the newly installed cartridge, and propagate the firmware to the additional cartridges when the enclosure manager determines the version of the firmware is updated compared with a firmware version of the plurality of cartridges. The enclosure manager can achieve a baseline of activity among the cartridges installed in the blade enclosure by propagating the updated firmware from the cartridge to the plurality of cartridges. The enclosure manager can automatically recognize the updated firmware and propagate the updated firmware to the plurality of cartridges. The enclosure manager can determine a difference in the version of the updated firmware using a HASH calculation.

### Example 2

A method is described herein. The method includes detecting, in an enclosure manager, a newly installed cartridge in an enclosure. The method also includes determining a firmware version of the newly installed cartridge. The method further includes determining that the firmware version of the newly installed cartridge is more current than an existing version of firmware. The method additionally includes propagating the firmware version of the newly installed cartridge to installed cartridges.

Propagating the firmware version of the newly installed cartridge can achieve a common baseline of behavior among the newly installed cartridge and the installed cartridges. The enclosure manager can manage a plurality of cartridges installed in the enclosure. The cartridge can act as a hardware delivery system of updated firmware. The cartridge can be installed only to propagate updated firmware to cartridges installed in the enclosure. Updated firmware can be automatically propagated to installed cartridges.

### Example 3

A tangible, non-transitory, machine-readable medium including machine-readable instructions executable by a processor is described herein. The instructions include code to direct a processor to detect a newly installed cartridge in an enclosure and determine a firmware version of the newly installed cartridge. The instructions also include code to direct a processor to determine that the firmware version of the newly installed cartridge is more current than an existing version of firmware. The instructions further include code to direct a processor to propagate the firmware version of the newly installed cartridge to installed cartridges.

The processor can manage a plurality of cartridges in the enclosure. The cartridge can act as a hardware delivery system of updated firmware. The processor can achieve a baseline of activity among cartridges installed in the enclosure by propagating the firmware from the newly installed cartridge to the installed cartridges.

The presently described technical examples may be susceptible to various modifications and alternative forms and have been shown only for illustrative purposes. For example, the present techniques support both reading and writing operations to a data structure cache. Furthermore, it is to be understood that the present techniques are not intended to be limited to the particular technical examples disclosed herein. Indeed, the scope of the appended claims is deemed to include all alternatives, modifications, and equivalents that are apparent to persons skilled in the art to which the disclosed subject matter pertains.

What is claimed is:

1. A computing system, comprising:
a blade enclosure to receive a plurality of cartridges; and
an enclosure manager in the blade enclosure to manage the plurality of cartridges;
the enclosure manager to determine that a cartridge includes updated firmware, and propagate the updated firmware to the plurality of cartridges.

2. The computing system of claim 1, wherein the enclosure manager is to:
register installation of a newly installed cartridge;
determine a version of the firmware of the newly installed cartridge; and
propagate the firmware to the additional cartridges when the enclosure manager determines the version of the firmware is updated compared with a firmware version of the plurality of cartridges.

3. The computing system of claim 1, wherein the enclosure manager achieves a baseline of activity among the cartridges installed in the blade enclosure by propagating the updated firmware from the cartridge to the plurality of cartridges.

4. The computing system of claim 1, wherein the enclosure manager automatically recognizes the updated firmware and propagates the updated firmware to the plurality of cartridges.

5. The computing system of claim 1, wherein the enclosure manager determines a difference in the version of the updated firmware using a HASH calculation.

6. A method, comprising:
detecting, in an enclosure manager, a newly installed cartridge in an enclosure;
determining a firmware version of the newly installed cartridge;
determining that the firmware version of the newly installed cartridge is more current than an existing version of firmware; and
propagating the firmware version of the newly installed cartridge to installed cartridges.

7. The method of claim 6, wherein propagating the firmware version of the newly installed cartridge achieves a common baseline of behavior among the newly installed cartridge and the installed cartridges.

8. The method of claim 6, wherein the enclosure manager manages a plurality of cartridges installed in the enclosure.

9. The method of claim 6, wherein the cartridge acts as a hardware delivery system of updated firmware.

10. The method of claim 6, wherein the cartridge is installed only to propagate updated firmware to cartridges installed in the enclosure.

11. The method of claim 6, wherein updated firmware is automatically propagated to installed cartridges.

12. A tangible, non-transitory, machine-readable medium comprising machine-readable instructions executable by a processor, the instructions comprising code to direct a processor to:
detect a newly installed cartridge in an enclosure;
determine a firmware version of the newly installed cartridge;
determine that the firmware version of the newly installed cartridge is more current than an existing version of firmware; and
propagate the firmware version of the newly installed cartridge to installed cartridges.

13. The tangible, non-transitory, machine-readable medium of claim 12, wherein the processor manages a plurality of cartridges in the enclosure.

14. The tangible, non-transitory, machine-readable medium of claim 13, wherein the cartridge acts as a hardware delivery system of updated firmware.

15. The tangible, non-transitory, machine-readable medium of claim 13, wherein the processor achieves a baseline of activity among cartridges installed in the enclosure by propagating the firmware from the newly installed cartridge to the installed cartridges.
